(19) United States
(12) Patent Application Publication
(10) Pub. No.: US 2014/0239674 A1
(43) Pub. Date: Aug. 28, 2014

(54) CONNECTING SYSTEM OF SIDE MEMBER FOR VEHICLE

(71) Applicants: Kia Motors Corporation, Seoul (KR); Hyundai Motor Company, Seoul (KR)

(72) Inventors: Seung Won AN, Seoul (KR); Seung Hyun KANG, Hwaseong-si (KR); Seong Woo CHOI, Hwaseong-si (KR); Hee Choul ROH, Hwaseong-si (KR)

(73) Assignees: KIA MOTORS CORPORATION, Seoul (KR); HYUNDAI MOTOR COMPANY, Seoul (KR)

(21) Appl. No.: 13/904,540

(22) Filed: May 29, 2013

(30) Foreign Application Priority Data
Feb. 27, 2013 (KR) 10-2013-0021058

(51) Int. Cl. B62D 27/02; B62D 25/02

(52) U.S. Cl. CPC B62D 27/023; B62D 25/025
USPC 296/209; 296/29

(57) ABSTRACT

A connecting system of a side member for a vehicle includes a member connecting member configured to connect a center side member and a rear side member provided at a floor of the vehicle in a length direction. The center side member, the rear side member, and a side sill are connected to one another through the member connecting member so as to improve frame rigidity and the center side member. The rear side member, the side sill, and the member connecting member are connected to a rear trailing arm mounting part, such that a moment occurrence is prevented and deformation of a car body is minimized to increase durability and to secure a battery mounting space, thereby making it possible to easily configure the layout.

### CROSS-REFERENCE TO RELATED APPLICATION

This application is based on and claims priority from Korean Patent Application No. 10-2013-0021058, filed on Feb. 27, 2013 in the Korean Intellectual Property Office, the disclosure of which is incorporated herein in its entirety by reference.

### BACKGROUND

1. Field

The present disclosure relates to a connecting system of a side member for a vehicle, and more particularly, to a connecting system of a side member for a vehicle for improving connecting force between a center side member and a rear side member which are main frames of the vehicle and securing a battery mounted space.

2. Background

In general, in a vehicle in which a side member is coupled to an upper portion of a rear floor, one side of the side member is provided with a side sill, and the trailing arm mounting bracket is seated on and coupled to the side member. A side member side of a vehicle has a trailing arm inserted into a space between mounting brackets and fixed by a joint bolt.

In the vehicle described above, in order to keep connectivity of a frame member coming from a front of a center cross member, a connection between the side sill and the side member is provided at the front, and the side member is extended along a rear wheel housing and is bended at a rear end portion of the center cross member to form a straight line.

In addition, a mounting position of the trailing arm is on the side member to which the side member and the side sill are connected, and the mounting bracket is installed at the position so as to couple the trailing arm.

As shown in FIG. 1, the vehicle of conventional design has a structure in which a center side member 10 is connected to a kickup part 40, and a rear side member 20 is connected to a side sill 30 and the kickup part 40. This structure has weak frame rigidity because the center side member 10 and the rear side member 20 which are main frame members are disconnected therebetween.

In order to solve this problem, there is a structure in which a flange of the center side member 10 is connected to the rear side member 20, recognizing importance of the connection between the center side member 10 and the rear side member 20. However, this structure is not a coupling between the members, but a simple flange coupling. Therefore, an effect on frame rigidity is not expected.

On the other hand, in the case of an electric car, as shown in FIGS. 2 and 3, a battery module needs to be mounted on a front of a rear trailing arm mounting part (not shown). However, in the case in which the battery module is mounted on the rear side member 20, the frame rigidity is weakened due to excessive step between a battery module frame and a car body mounting part, and a space between a rear trailing arm mounting and a battery mounting is decreased.

### SUMMARY

Accordingly, the present disclosure has been made to solve the above-mentioned problems while advantages achieved are maintained intact.

One advantage to be achieved by the present disclosure is to provide a connecting system of a side member for a vehicle, and more particularly, to a connecting system of a side member for a vehicle for improving a connecting force between a center side member and a rear side member which are main frames of the vehicle and securing a battery mounted space.

In one aspect of the present disclosure, there is provided a connecting system of a side member for a vehicle, the connecting system including: a member connecting member configured to mutually connect a center side member and a rear side member provided at a floor of the vehicle in a length direction.

A side end of the floor of the vehicle may be provided with a side sill, wherein the side sill is in parallel with the center side member.

A flange may be extendedly formed at an end of the center side member in a side direction to be mutually connected to the side sill.

The member connecting member connecting the center side member, the rear side member, and the side sill may be connected to a rear trailing arm mounting part provided at a rear of the vehicle to prevent a moment occurrence.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a view showing a conventional connecting device of a side member for a vehicle;

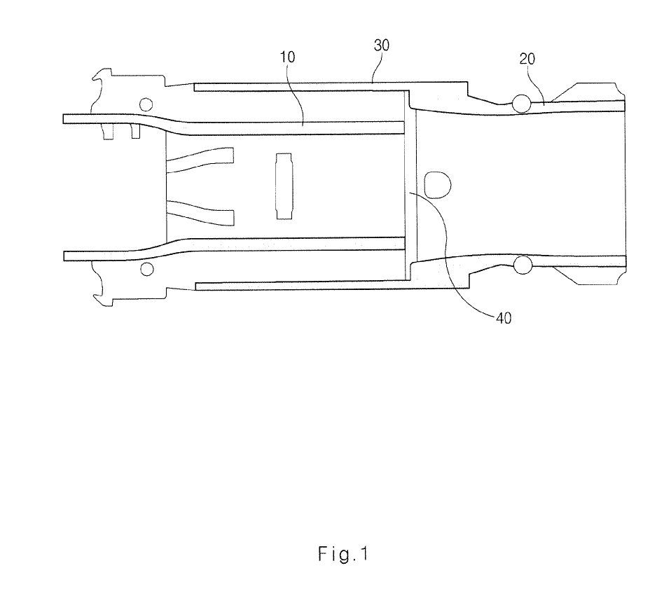

FIG. 2 is a view showing a battery mounting structure for an electric car in the conventional connecting device of the side member for the vehicle;

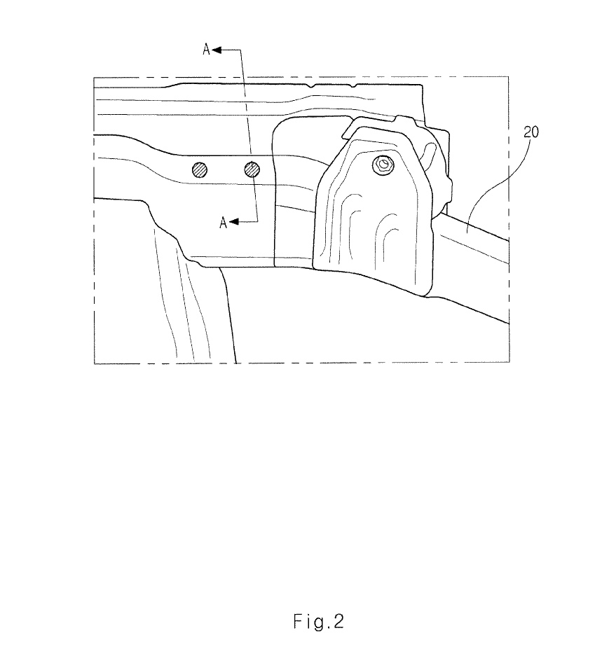

FIG. 3 is a cross-sectional view taken along the line A-A of FIG. 2;

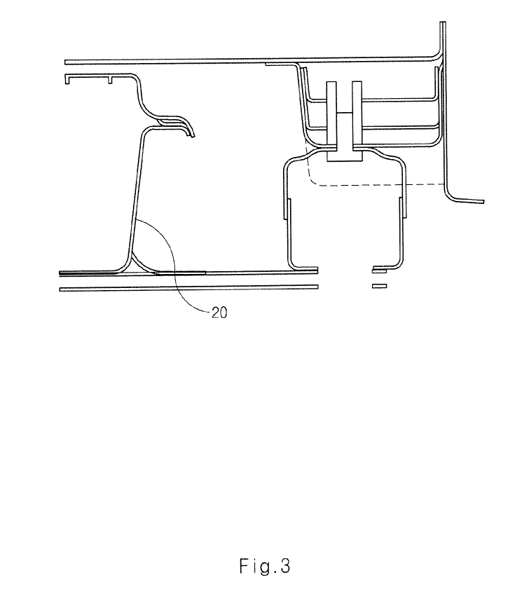

FIG. 4 is a view showing a connecting system of a side member for a vehicle according to an embodiment the present disclosure;

FIG. 5 is a cross-sectional view taken along the line X-X of FIG. 4;

FIG. 6 is a view showing a state before mounting a battery for an electric car in the connecting system of the side member for the vehicle according to an embodiment of the present disclosure;

FIG. 7 is a view showing a state after mounting the battery for the electric car in the connecting system of the side member for the vehicle according to an embodiment of the present disclosure; and

FIG. 8 is a graph comparing torsion angles of a conventional device and the present disclosure.

### DETAILED DESCRIPTION

Exemplary embodiments of the present disclosure will be described in detail with reference to the accompanying drawings.

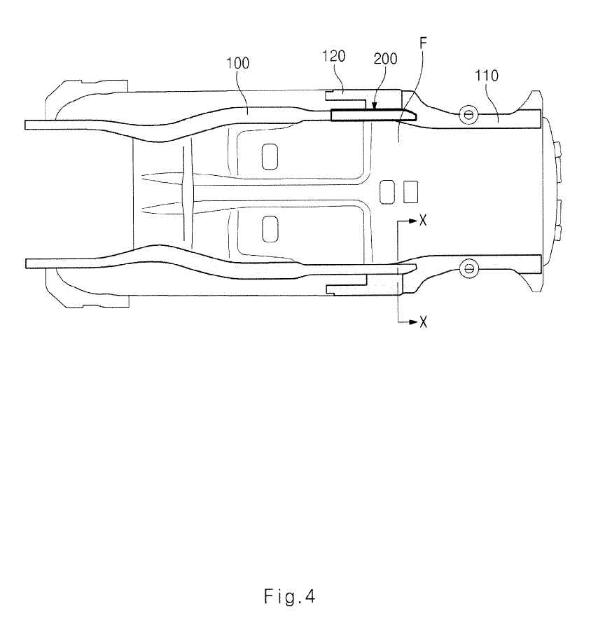

A connecting system of a side member for a vehicle according to the present disclosure includes a member connecting member 200 connecting a center side member 100 and a rear side member 110 included in the vehicle, as shown in FIGS. 4 to 8.

As shown in FIGS. 4 to 7, the center side member 100 and the rear side member 110 are provided at opposing ends of a floor F of the vehicle in a length direction. The member connecting member 200 is provided between the center side member 100 and the rear side member 110 in the length direction so as to connect the center side member 100 and the rear side member 110.

Meanwhile, a side end of the floor F of the vehicle is provided with a side sill 120 which is disposed in parallel with the center side member 100.

In this configuration, a flange 130 is extendedly formed at a side of an end of the center side member 100, such that the center side member 100 and the side sill 120 are connected to each other.

As a result, the center side member 100, the rear side member 110, and the side sill 120 are connected to the member connecting member 200.

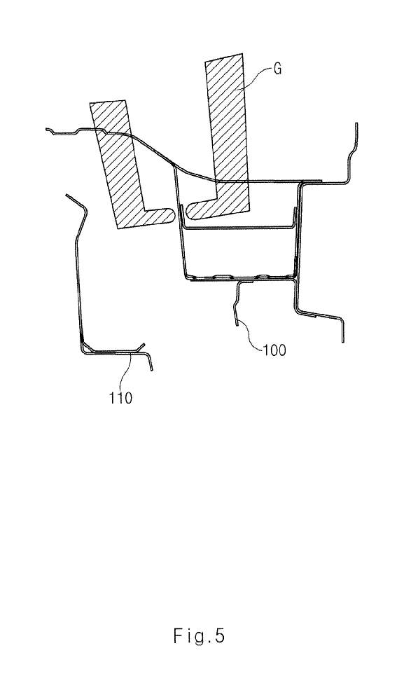

As such, in an embodiment of the present disclosure, the center side member 100 and the rear side member 110 are connected through the member connecting member 200, thereby maximizing frame rigidity. At the same time, as shown in FIG. 5, a 2PIECE cross-section structure in a shape of ‘I’ and ‘L’ is applied to the center side member 100 and the member connecting member 200, in order to increase the convenience of welding when using a welding gun G.

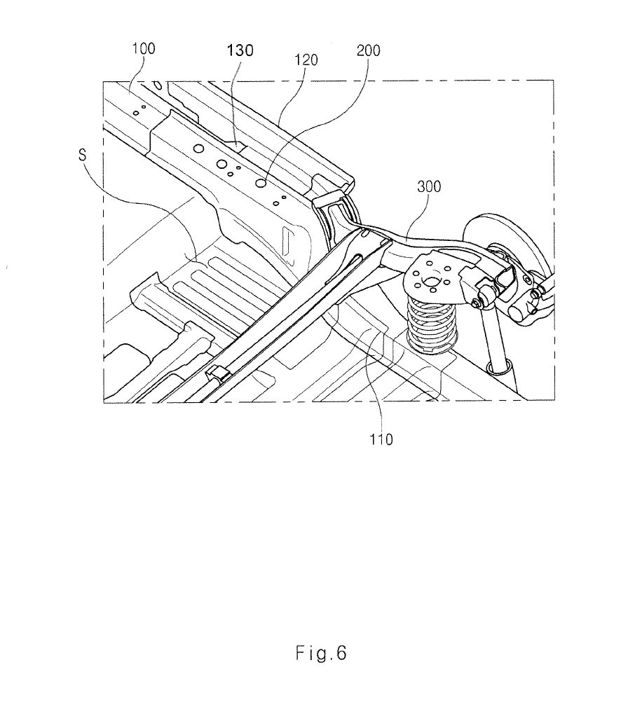

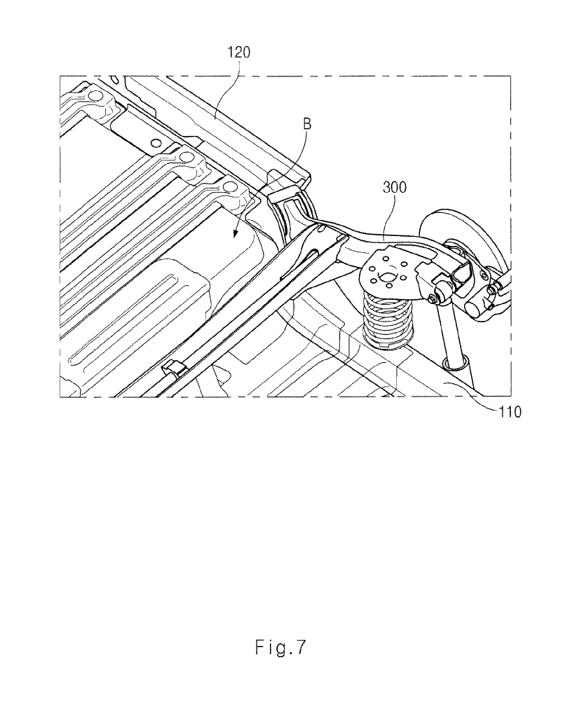

In addition, as shown in FIGS. 6 and 7, the member connecting member 200 connected to the center side member 100, the rear side member 110, and the side sill 120, is also connected to a rear trailing arm mounting part 300 provided at a rear of the vehicle.

In this configuration, as shown in FIG. 6, a space S is formed between both of the center side members 100 forming the floor F, thereby making it possible to mount a battery B between a front of the rear trailing arm mounting part 300 and the center side member 100. In the case in which the connecting system of the present disclosure is applied to an electric car, the battery B may be mounted on the floor F of the vehicle, such that the difficulty of configuring a car body layout due to space insufficiency of conventional vehicles is solved, thereby making it possible to improve marketability.

In addition, in the embodiment in which the member connecting member 200 connected to the center side member 100, the rear side member 110, and the side sill 120 is connected to the rear trailing arm mounting part 300, a phenomenon in which a moment is generated from the rear trailing arm mounting part 300 may be prevented and a supporting force for a load may be improved.

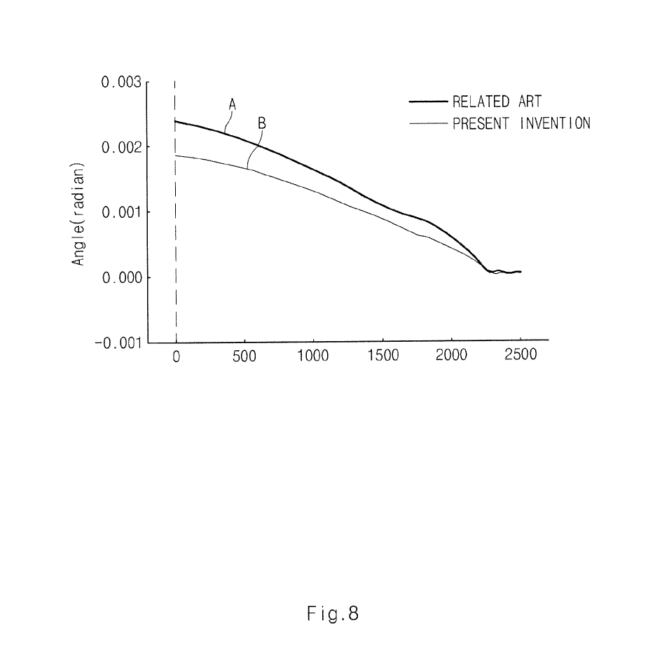

FIG. 8 is a graph showing torsion diagrams of a conventional system as compared to the present disclosure. In the case of a conventional system A, since the center side member and the rear side member are disconnected, it may be appreciated that a torsion angle of a side of the rear trailing arm mounting part is higher than a torsion angle of a side of the rear trailing arm mounting part 300 of the center side member 100 and the rear side member 110 connected through the member connecting member 200 according to the present disclosure B.

As set forth above, the connection system of the present disclosure may decrease the amount of car body deformation and improve the riding quality and durability due to the connection between the center side member 100 and the rear side member 110 through the member connecting member 200.

As set forth above, the present disclosure may improve frame rigidity by connecting the center side member, the rear side member, and the side sill through the member connecting member. The connecting system of the present disclosure may also prevent moment occurrence and minimize deformation of the car body by connecting the center side member, the rear side member, the side sill, and the member connecting member to the rear trailing arm mounting part. As a result of this configuration, vehicle durability is increased and the battery mounting space is secured, thereby making it possible to easily configure the layout.

As described above, although the present disclosure has been described with reference to exemplary embodiments and the accompanying drawings, it would be appreciated by those skilled in the art that the present disclosure is not limited thereto but various modifications and alterations might be made without departing from the scope defined in the following claims.

What is claimed is:

1. A connecting system of a side member for a vehicle, the connecting system comprising:
a member connecting member configured to mutually connect a center side member and a rear side member provided at a floor of the vehicle in a length direction.

2. The connecting system according to claim 1, wherein a side end of the floor of the vehicle is provided with a side sill, the side sill being in parallel with the center side member.

3. The connecting system according to claim 2, wherein a flange is extendedly formed at an end of the center side member in a side direction and mutually connected to the side sill.

4. The connecting system according to claim 3, wherein the member connecting member connecting the center side member, the rear side member, and the side sill is connected to a rear trailing arm mounting part provided at a rear of the vehicle and configured to prevent a moment occurrence.
